(19) United States
(12) Patent Application Publication
(10) Pub. No.: US 2025/0237891 A1
(43) Pub. Date: Jul. 24, 2025

(54) ASYMMETRIC ORTHOKERATOLOGY LENS

(71) Applicant: Shanghai FULO Medical Instrument Co., Ltd., Shanghai (CN)

(72) Inventors: Baoguang JIANG, Shanghai (CN); MOTOTORA KAI, Shanghai (CN); An LI, Shanghai (CN)

(73) Assignee: Shanghai FULO Medical Instrument Co., Ltd., Shanghai (CN)

(21) Appl. No.: 18/614,761

(22) Filed: Mar. 25, 2024

(30) Foreign Application Priority Data
Jan. 18, 2024 (CN) 202410071150.5

(51) Int. Cl. G02C 7/06

(52) U.S. Cl. CPC G02C 7/066

(57) ABSTRACT

An asymmetric orthokeratology lens includes a base curve zone, and a reverse curve zone, an adaptation curve zone and a peripheral curve zone that are successively formed outward from a periphery of the base curve zone. An outer edge of the base curve zone and an outer edge of the reverse curve zone together form a first annular structure. Space defined between a half-ring of the first annular structure on a nasal side and a cornea is larger than space defined between a half-ring of the first annular structure on a bitemporal side and the cornea. When the asymmetric orthokeratology lens is worn, an amount of tears filled between the nasal side and the cornea is different from an amount of tears filled between the bitemporal side and the cornea in the reverse curve zone, and negative pressures on the nasal side and the bitemporal side are also different.

### CROSS-REFERENCE TO RELATED APPLICATIONS

This application claims priority to Chinese Patent Application No. 202410071150.5 with a filing date of Jan. 18, 2024. The content of the aforementioned application, including any intervening amendments thereto, is incorporated herein by reference.

### TECHNICAL FIELD

The present disclosure relates to the technical field of orthokeratology lenses, and in particular to an asymmetric orthokeratology lens.

### BACKGROUND

The orthokeratology lens has become one of the most widely used means in myopia prevention and control in the world due to its effectiveness and safety in myopia prevention and control. The mechanism is that after the orthokeratology lens is worn overnight, the lens continuously applies a positive pressure on a central zone of the cornea. In this way, the epithelial cells in the central zone of the cornea are forced to migrate toward a periphery, to form a relatively flat treatment zone with a flat center and a defocusing ring with rising periphery. Due to the defocusing ring, the middle retina and peripheral retina are in a myopic defocusing state, to slow down growth of eye axes and delay an increase in the degree of myopia.

An existing orthokeratology lens generally includes four curve zones, namely, a base curve zone, a reverse curve zone, an adaptation curve zone, and a peripheral curve zone. From a top view of the lens, the base curve zone is circular, and the remaining three zones are equally-wide annular band zones. Under a condition that the lens is centrally positioned at the cornea and well-shaped, theoretically, a defocusing ring centered on the center of the cornea may be formed. Defocusing amounts generated in the middle retina and the peripheral retina by the defocusing ring are more uniform, while a defocusing amount generated at a maximum periphery at an axial position is small. As a result, effective prevention and control for myopia cannot be implemented.

### SUMMARY OF PRESENT INVENTION

In view of this, an objective of the present disclosure is to provide an asymmetric orthokeratology lens, to resolve the foregoing technical problems in the background.

The present disclosure provides an asymmetric orthokeratology lens. The asymmetric orthokeratology lens includes a base curve zone, and a reverse curve zone, an adaptation curve zone, and a peripheral curve zone that are successively formed outward from a periphery of the base curve zone, where an outer edge of the base curve zone is combined with an outer edge of the reverse curve zone, to form a first annular structure, and space defined between a half-ring of the first annular structure on a nasal side and a cornea is larger than space defined between a half-ring of the first annular structure on a bitemporal side and the cornea.

In one embodiment, outer edges of the base curve zone, the adaptation curve zone, and the peripheral curve zone are all circles whose center points are coincident with each other, and a central point of the outer edge of the reverse curve zone is offset facing the nasal side, with a center point of the base curve zone as a reference point, to enable a width of the first annular structure located on the nasal side to be larger than a width of the first annular structure located on the bitemporal side.

In one embodiment, the outer edge of the reverse curve zone is a circle or an ellipse.

In one embodiment, outer edges of the base curve zone, the adaptation curve zone, and the peripheral curve zone are all circles whose center points are coincident with each other, and the outer edge of the reverse curve zone is surrounded by a semi-circular curve and a semi-elliptic curve. A center point of the semi-circular curve and a central point of the semi-elliptic curve coincide with a center point of the base curve zone. The semi-circular curve surrounds a side, facing the bitemporal side, of the base curve zone. The semi-elliptic curve surrounds a side, facing the nasal side, of the base curve zone. A distance from a point on the semi-elliptic curve to the center point of the base curve zone is greater than or equal to a distance from a point on the semi-circular curve to the center point of the base curve zone, to enable a width of the first annular structure located on the nasal side to be greater than a width of the first annular structure located on the bitemporal side.

Outer edges of the reverse curve zone, the adaptation curve zone, and the peripheral curve zone are all circles whose center points are coincident with each other. An outer edge of the base curve zone is surrounded by a semi-circular curve and a semi-elliptic curve. A center point of the semi-circular curve and a central point of the semi-elliptic curve coincide with a center point of the reverse curve zone, the semi-circular curve is set facing the bitemporal side, the semi-elliptic curve is set facing the nasal side. A distance from a point on the semi-elliptic curve to the center point of the reverse curve zone is less than or equal to a distance from a point on the semi-circular curve to the center point of the reverse curve zone, to enable a width of the first annular structure located on the nasal side to be greater than a width of the first annular structure located on the bitemporal side.

In one embodiment, an inner surface of the base curve zone is flat, the reverse curve zone includes a first curve zone and a second curve zone that are continuously bent outward from the periphery of the base curve zone, and a curvature of an inner surface of the first curve zone is less than or equal to a curvature of an inner surface of the second curve zone.

In one embodiment, values of sagittal depths from points on an outer edge of the first curve zone to the base curve zone are the same.

In one embodiment, a distance from an outer edge of the first curve zone in the bitemporal side to the base curve zone is equal to a distance from an outer edge of the first curve zone in the nasal side to the base curve zone.

A distance from an outer edge of the second curve zone in the bitemporal side to the first curve zone is less than a distance from the outer edge of the second curve zone in the nasal side to the first curve zone.

In one embodiment, the distance from the outer edge of the second curve zone in the bitemporal side to the first curve zone is set to be X1, the distance from the outer edge of the second curve zone in the nasal side to the first curve zone is set to X2, and a difference between X2 and X1 is 0.1 mm to 0.4 mm.

In one embodiment, the distance from the outer edge of the first curve zone in the bitemporal side to the base curve zone is set to X3, and a ratio of X3 to X1 is 1/3.

In one embodiment, outer edges of the base curve zone, the reverse curve zone, the adaptation curve zone, and the peripheral curve zone are all circles whose center points are coincident with each other, to enable the first annular structure to form a circular ring. A curvature of an inner surface, located on the nasal side, of the circle is greater than a curvature of an inner surface, located on the bitemporal side, of the circle.

In one embodiment, an inner surface of the base curve zone is flat, and the reverse curve zone includes a first curve zone and a second curve zone that are continuously bent outward from the periphery of the base curve zone. A curvature of an inner surface, located on the nasal side, of the first curve zone is equal to a curvature of an inner surface, located on the bitemporal side, of the first curve zone, or a curvature of an inner surface, located on the nasal side, of the second curve zone is greater than a curvature of an inner surface, located on the bitemporal side, of the second curve zone.

Compared with the prior art, the present disclosure has the following beneficial effects:

Space defined between a half-ring of the first annular structure on the nasal side and a cornea is larger than space defined between a half-ring of the first annular structure on the bitemporal side and the cornea. Therefore, when the asymmetric orthokeratology lens is worn, an amount of tears filled between the nasal side and the cornea is different from an amount of tears filled between the bitemporal side and the cornea in the reverse curve zone, and negative pressures on the nasal side and the bitemporal side are also different. A defocusing ring may be formed at the cornea on the nasal side as far as possible. This effectively improves prevention and control effect of the asymmetric orthokeratology lens on myopia.

### BRIEF DESCRIPTION OF THE DRAWINGS

The above and/or additional aspects and advantages of the present disclosure will become apparent and easy to understand from the description of the embodiments with reference to the following drawings.

FIG. 1 is a schematic diagram showing a structure of an asymmetric orthokeratology lens according to an implementation in an embodiment 1 of the present disclosure;

FIG. 2 is a schematic diagram showing a structure of an asymmetric orthokeratology lens according to another implementation in an embodiment 1 of the present disclosure;

FIG. 3 is a schematic diagram showing a cross-section of an asymmetric orthokeratology lens at a non-flattest half-axis according to an embodiment 1 of the present disclosure;

FIG. 4 is a schematic diagram showing a structure of an asymmetric orthokeratology lens according to an embodiment 2 of the present disclosure;

FIG. 5 is a schematic diagram showing a structure of an asymmetric orthokeratology lens according to an embodiment 3 of the present disclosure;

FIG. 6 is a schematic diagram showing a structure of an asymmetric orthokeratology lens according to an embodiment 4 of the present disclosure; and

FIG. 7 is a schematic diagram showing a cross-section of an asymmetric orthokeratology lens at a non-flattest half-axis according to an embodiment 4 of the present disclosure.

### REFERENCE NUMERALS

1. base curve zone; 2. reverse curve zone; 21. first curve zone; 22. second curve zone; 3. adaptation curve zone; 31. third curve zone; 32. fourth curve zone; 4. peripheral curve zone; 5. bitemporal side; 6. nasal side; 7. cornea.

### DETAILED DESCRIPTION OF THE EMBODIMENTS

To facilitate the understanding of the present disclosure, the present disclosure is described more completely below with reference to the accompanying drawings. Pluralities of embodiments of the present disclosure are shown in the drawings. However, the present disclosure is embodied in various forms without being limited to the embodiments set forth herein. Rather, these embodiments are provided so that the disclosure of the present disclosure will be understood more thoroughly and comprehensively.

It should be noted that, when a component is fixed to another component, the component may be fixed to the other component directly or via an intermediate component. When a component is connected to another component, the component may be connected to the another component directly or via an intermediate component. The terms “vertical”, “horizontal”, “left”, and “right” and similar expressions used herein are for illustrative purposes only.

Unless otherwise defined, all technical and scientific terms used herein have the same meanings as commonly understood by those skilled in the technical field of the present disclosure. The terms used in the specification of the present disclosure herein are only for the purpose of describing specific embodiments, and are not intended to limit the present disclosure. The term “and/or” used herein includes one or more of the associated items listed.

### Embodiment 1

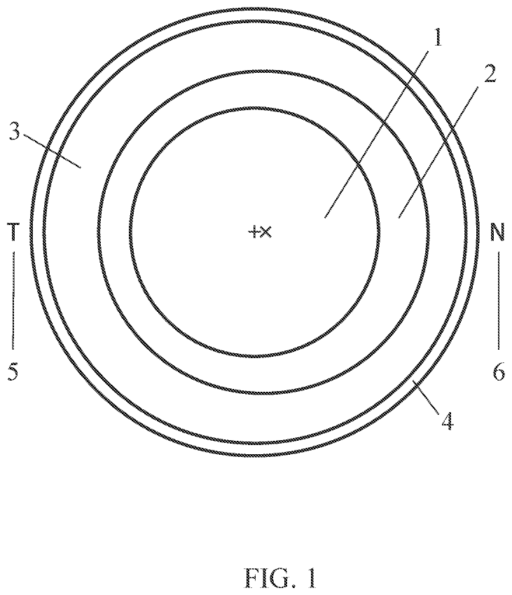

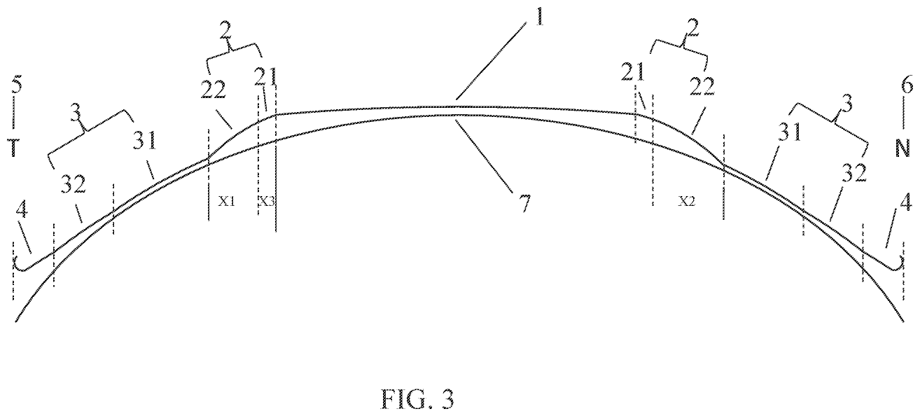

Referring to FIG. 1 and FIG. 3, an embodiment 1 of the present disclosure provides an asymmetric orthokeratology lens. The asymmetric orthokeratology lens includes a base curve zone 1, and a reverse curve zone 2, an adaptation curve zone 3, and a peripheral curve zone 4 that are successively formed outward from a periphery of the base curve zone 1. An outer edge of the reverse curve zone 2 is combined with an outer edge of the base curve zone 1, to form a first annular structure. Space defined between a half-ring of the first annular structure on a nasal side 6 and a cornea 7 is larger than space defined between a half-ring of the first annular structure on a bitemporal side 5 and the cornea 7.

It may be understood that the space defined between the half-ring of the first annular structure located on the nasal side 6 and the cornea 7 is larger than the space defined between the half-ring of the first annular structure located on the bitemporal side 5 and the cornea 7. Therefore, when the asymmetric orthokeratology lens is worn, an amount of tears filled between the nasal side and the cornea 7 is different from an amount of tears filled between the bitemporal side and the cornea 7 in the reverse curve zone 2, and negative pressures on the nasal side and the bitemporal side are also different. A defocusing ring may be formed at the cornea 7 on the nasal side 6 as far as possible. This effectively improves prevention and control effect of the asymmetric orthokeratology lens on myopia.

Specifically, referring to FIG. 1, outer edges of the base curve zone 1, the adaptation curve zone 3, and the peripheral curve zone 4 are all circles whose center points are coincident with each other. A central point of the outer edge of the reverse curve zone 2 is offset facing the nasal side 6 with a center point of the base curve zone 1 as a reference point, to enable a width of the first annular structure located on the nasal side 6 to be larger than a width of the first annular structure located on the bitemporal side 5. The outer edge of the reverse curve zone 2 is an ellipse. In FIG. 1, + represents the center point of the base curve zone 1, and x represents the center point of the reverse curve zone 2.

It may be understood that the central point of the outer edge of the reverse curve zone 2 is offset facing the nasal side 6, with the center point of the base curve zone 1 as a reference point, to enable a projected area of the half-ring of the first annular structure disposed at the cornea 7 on the nasal side 6 to be larger than a projected area of the half-ring of the first annular structure disposed at the cornea 7 on the bitemporal side 5. Therefore, the space defined between the half-ring of the first annular structure located on the nasal side 6 and the cornea 7 is greater than the space defined between the half-ring of the first annular structure located on the bitemporal side 5 and the cornea 7. This ensures that in the reverse curve zone 2, the amount of tears filled between the nasal side and the cornea 7 is not equal to the amount of tears filled between the bitemporal side and the cornea 7, and negative pressures on the nasal side and the bitemporal side are different. Filling of the tears and distribution of a force may be optimized, so that the defocusing ring may be formed at the cornea 7 toward the nasal side 6. Therefore, prevention and control effect of the asymmetric orthokeratology lens on myopia is better.

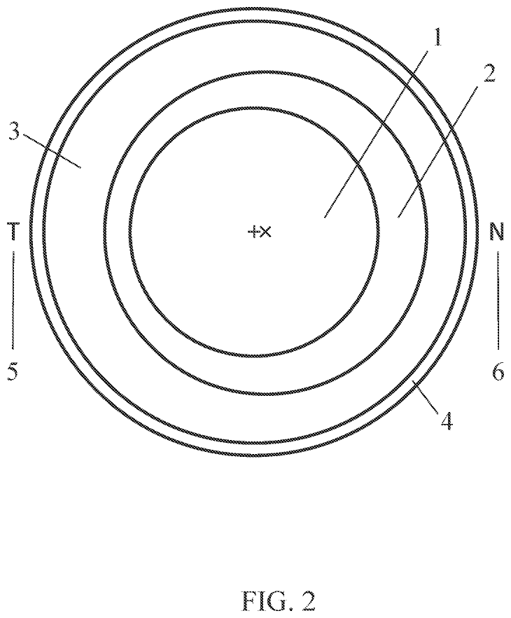

In addition, the outer edge of the reverse curve zone 2 may also be a circle. Refer to FIG. 2 for details. This embodiment is merely an example and not limited, and may be adjusted according to actual needs.

It is worth mentioning that the outer edge of the reverse curve zone 2 is combined with the outer edge of the adaptation curve zone 3, to form a second annular structure. When the central point of the outer edge of the reverse curve zone 2 is offset facing the nasal side 6, a width of the second annular structure located on the nasal side 6 is less than a width of the second annular structure located on the bitemporal side 5.

Further, referring to FIG. 3, an inner surface of the base curve zone 1 is flat, and is used to flatten a center part of the cornea 7 for vision correction. The reverse curve zone 2 includes a first curve zone 21 and a second curve zone 22 that are continuously bent outward from the periphery of the base curve zone 1. A curvature of an inner surface of the first curve zone 21 is less than or equal to a curvature of an inner surface of the second curve zone 22.

It needs to be explained that, because a distance from a point on an outer edge of the second curve zone 22 to a point on an outer edge of the first curve zone 21 is not a constant, a curvature of the inner surface of the second curve zone 22 in a circumferential direction varies with an angle, and is a range value. Specifically, in this embodiment, according to a corneal 7 topography, when a cross-section in which a flattest half-axis of the cornea 7 is located is intercepted, the curvature of the inner surface of the first curve zone 21 is equal to the curvature of the inner surface of the second curve zone 22. In a cross-section of a remaining half-axis, the curvature of the inner surface of the first curve zone 21 is smaller than the curvature of the inner surface of the second curve zone 22. Specifically, FIG. 3 shows the cross-section in which a non-flattest half-axis of the cornea 7 is located. It can be seen from the figure that the inner surface of the first curve zone 21 is flatter than the inner surface of the second curve zone 22, and is used for smooth transition of a curvature between the base curve zone 1 and the second curve zone 22, to strengthen compressive resistance of the lens, and effectively resolve a problem that the lens is easy to break and deform due to inward folding with a large angle at a junction of the base curve zone 1 and the reverse curve zone 2, so that safety and durability of the lens are improved.

Still referring to FIG. 3, values of sagittal depths from points on an outer edge of the first curve zone 21 to the base curve zone 1 are the same. This means that the curvature of the inner surface of the first curve zone 21 in the circumferential direction is a constant, to enable a value of a sagittal depth from the inner surface of the outer edge of the first curve zone 21 in the cross-section of the flattest semi-axis to an apex of the lens to be equal to a value of a sagittal depth of the inner surface of the outer edge of the first curve zone 21 in the cross-section of the remaining semi-axis. This ensures that a sufficient amount of tears is stored in the reverse curve zone 2, to generate a sufficiently large negative pressure, and form a defocusing ring with a greater defocusing amount at the cornea 7. The defocusing ring has better prevention and control effect on myopia. Because the defocusing ring may generate defocusing effect in a wider zone of the cornea 7, growth of eye axes slows down, and an increase in the degree of myopia is delayed.

As shown in FIG. 3, a distance from an outer edge of the first curve zone 21 on the bitemporal side 5 to the base curve zone 1 is equal to a distance from an outer edge of the first curve zone 21 on the nasal side 6 to the base curve zone 1. Specifically, in this embodiment, the outer edge of the first curve zone 21 is a circle whose center point coincides with the center point of the base curve zone 1. The outer edge of the first curve zone 21 is combined with the outer edge of the base curve zone 1, to form a circular ring, and a width of the circular ring on the nasal side 6 is equal to a width of the circular ring on the bitemporal side 5.

A distance from an outer edge of the second curve zone 22 on the bitemporal side 5 to the first curve zone 21 is less than a distance from an outer edge of the second curve zone 22 on the nasal side 6 to the first curve zone 21. It may be understood that, in this embodiment, the outer edge of the second curve zone 22 is the outer edge of the reverse curve zone 2. Therefore, compared to a distance from an outer edge of the second curve zone 22 on the bitemporal side 5 to the first curve zone 21, a distance from an outer edge of the second curve zone 22 on the nasal side 6 to the first curve zone 21 is wider, so that a curvature value is smaller. As a result, the tears between the reverse curve zone 2 and the cornea 7 are not equally filled in the nasal side 6 and the bitemporal side 5, and relative negative pressures formed on the nasal side 6 and the bitemporal side 5 are not equal. When the center of the cornea 7 is flattened, relative bulges formed on the nasal side 6 and the bitemporal side 5 are not equal. Due to an asymmetric defocusing ring formed at the periphery of the cornea 7, a defocusing rate at a maximum periphery is increased, so that prevention and control effect on myopia is better.

It is worth mentioning that the outer edge of the first curve zone 21 is combined with the outer edge of the base curve zone 1, to form a circle. An objective of this design is to enable transition between the first curve zone 21 and the base curve zone 1 to be smoother, so as to ensure that a pressure applied by the lens on the cornea 7 is evenly distributed. Through this smooth transition, the lens may better facilitate changes in the curvature of the cornea 7, to improve adaptability and stability. In addition, the design of this circular is conducive to ensuring that the curvature of the inner surface of the first curve zone 21 in the circumferential direction is a constant, to provide uniform pressure in the first curve zone 21 in all directions. Uniformity of the curvature of the inner surface of the first curve zone 21 may be ensured, so that a risk of uneven pressure on the cornea 7 can be reduced, and comfort and safety of wearing can be improved.

In addition, in practical application, a design of a size of the reverse curve zone 2 is of great significance for improving prevention and control effect on myopia, adaptability, stability, and safety. In this embodiment, requirements for the design of a size design of the reverse curve zone 2 are as follows. Specifically, as shown in FIG. 3, a distance from the outer edge of the second curve zone 22 on the bitemporal side 5 to the first curve zone 21 is set to X1, a distance from the outer edge of the second curve zone 22 on the nasal side 6 to the first curve zone 21 is set to X2, and a difference between X2 and X1 is controlled within 0.1 mm to 0.4 mm. Therefore, morphological differences in corneas 7 of different individuals are better adapted, so that adaptability and stability of the lens are improved, and shaping of the cornea 7 and prevention and control effect on myopia are better achieved.

Further, a distance from the outer edge of the first curve zone 21 on the bitemporal side 5 to the base curve zone 1 is set to X3, and a ratio of X3 to X1 is 1/3. This design is conducive to balancing distribution of tears between the lens and the cornea 7, reduces influence of flowing of tears on the shaping effect, and improves stability of the lens.

As shown in FIG. 3, the adaptation curve zone 3 includes a third curve zone 31 and a fourth curve zone 32 formed by continuously bending outward from a periphery of the second curve zone 22. The third curve zone 31 is combined with the fourth curve zone 32, to form a second annular structure. In all circumferential directions of the second annular structure, a curvature of an inner surface of the fourth curve zone 32 is smaller than a curvature of an inner surface of the third curve zone 31. Therefore, the fourth curve zone 32 is flatter in comparison to the third curve zone 31, and is used to accommodate an irregular surface of the corneal 7, so that accuracy of positioning and stability of the lens are improved.

Further, the outer edge of the peripheral curve zone 4 is bent toward a direction opposite to the cornea 7, to form a reflex hook portion. The tears may be effectively guided to flow along the reflex hook portion, to ensure that the tears flow circularly, and reduce discomfort of a user. Secondly, air may more easily circulate in a gap between the lens and the cornea 7, to improve an oxygen transmission coefficient of the lens.

It should be noted that in this embodiment, inner surfaces of the first curve zone 21, the second curve zone 22, the third curve zone 31, and the fourth curve zone 32 are connected to form a smooth curved surface, to facilitate processing and production. In addition, comfort and safety of wearing are improved.

In summary, according to the asymmetric orthokeratology lens provided in this embodiment of the present disclosure, the space defined between the half-ring of the first annular structure located on the nasal side 6 and the cornea 7 is greater than the space defined between the half-ring of the first annular structure located on the bitemporal side 5 and the cornea 7. Therefore, when the asymmetric orthokeratology lens is worn, in the reverse curve zone 2, the amount of tears filled between the nasal side and the cornea 7 is not equal to the amount of tears filled between the bitemporal side and the cornea 7, and negative pressures on the nasal side and the bitemporal side are different. The defocusing ring may be formed at the cornea 7 on the nasal side 6 as far as possible. This effectively improves prevention and control effect of the asymmetric orthokeratology lens on myopia.

### Embodiment 2

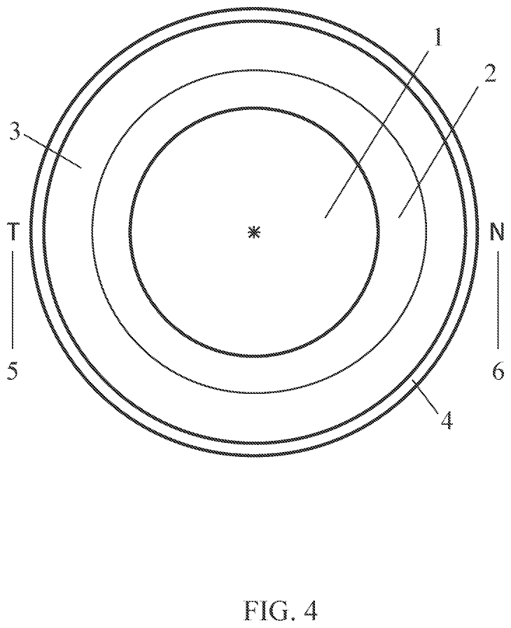

FIG. 4 shows an asymmetric orthokeratology lens in the embodiment 2 of the present disclosure. Differences between the asymmetric orthokeratology lens in this embodiment and the asymmetric orthokeratology lens in the embodiment 1 in that: Outer edges of a base curve zone 1, an adaptation curve zone 3, and a peripheral curve zone 4 are all circles whose center points are coincident with each other. An outer edge of the reverse curve zone 2 is surrounded by a semi-circular curve and a semi-elliptic curve. A center point of the semi-circular curve and a central point of the semi-elliptic curve coincide with a center point of the base curve zone 1. The semi-circular curve surrounds a side, facing a bitemporal side 5, of the base curve zone 1. The semi-elliptic curve surrounds a side, facing a nasal side 6, of the base curve zone 1. A distance from a point on the semi-elliptic curve to the center point of the base curve zone 1 is greater than or equal to a distance from a point on the semi-circular curve to the center point of the base curve zone 1, to enable a width of a first annular structure located on the nasal side 6 to be greater than a width of the first annular structure located on the bitemporal side 5.

It may be understood, a semi-circular curve is combined with an outer edge of the base curve zone 1 on the bitemporal side 5, to form one half of the first annular structure, and a semi-elliptic curve is combined with an outer edge of the base curve zone 1 on the nasal side 6, to form the other half of the first annular structure. In comparison to the solution of forming the first annular structure by offsetting the central point of the outer edge of the reverse curve zone 2 in the embodiment 1, the semi-circular curve is combined with the outer edge of the base curve zone 1, to form an equally-wide half-ring structure. Therefore, in the reverse curve zone 2, a requirement that a negative pressure between the nasal side and the cornea 7 and a negative pressure between the bitemporal side and the cornea 7 are different is met. In addition, in the reverse curve zone 2, tears may be more evenly filled between the bitemporal side 5 and the cornea 7. This design reduces possibility of stagnation of tears, promotes the smooth circulation of tears, and improves comfort of wearing.

### Embodiment 3

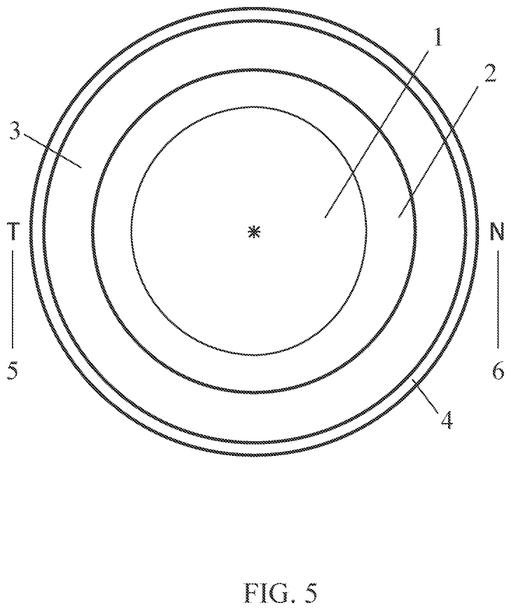

FIG. 5 shows an asymmetric orthokeratology lens in the embodiment 3 of the present disclosure. Differences between the asymmetric orthokeratology lens in this embodiment and the asymmetric orthokeratology lens in the embodiment 1 in that: Outer edges of a reverse curve zone 2, an adaptation curve zone 3, and a peripheral curve zone 4 are all circles whose center points are coincident with each other. An outer edge of the base curve zone 1 is surrounded by a semi-circular curve and a semi-elliptic curve. A center point of the semi-circular curve and a central point of the semi-elliptic curve coincide with a center point of the reverse curve zone 2, the semi-circular curve is set facing a bitemporal side 5, the semi-elliptic curve is set facing a nasal side 6. A distance from a point on the semi-elliptic curve to the center point of the reverse curve zone 2 is less than or equal to a distance from a point on the semi-circular curve to the center point of the reverse curve zone 2, to enable a width of a first annular structure located on the nasal side 6 to be greater than a width of the first annular structure located on the bitemporal side 5. It should be noted that, in this embodiment, deformation is made based on the embodiment 2, and technical effect that is the same as that in the embodiment 2 can be implemented, and thus will not be described in detail.

### Embodiment 4

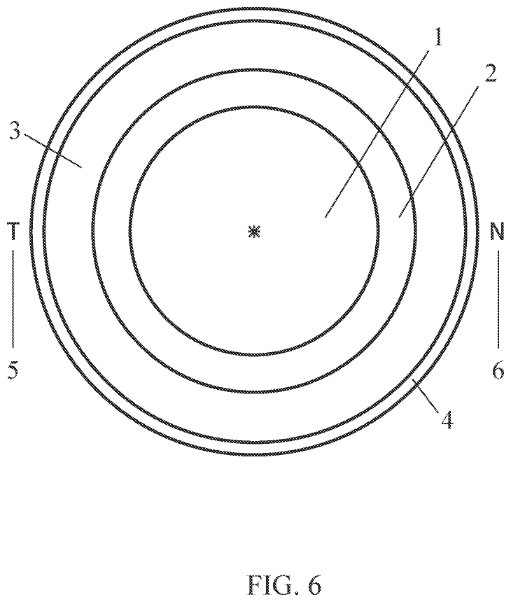

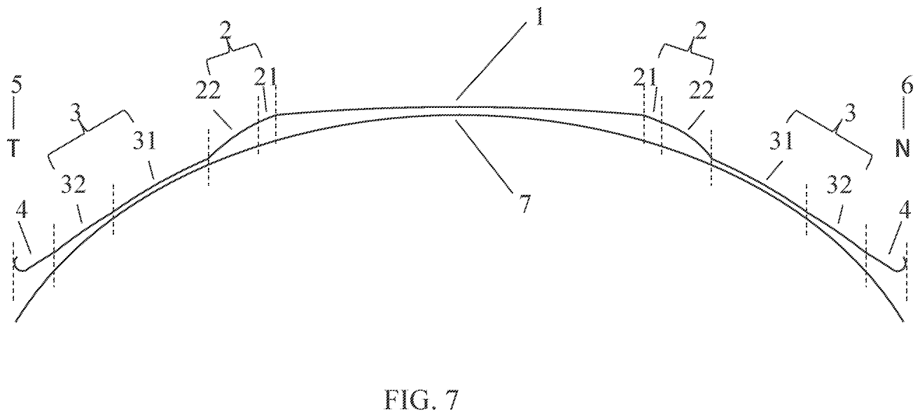

FIG. 6 and FIG. 7 show an asymmetric orthokeratology lens in the embodiment 4 of the present disclosure. Differences between the asymmetric orthokeratology lens in this embodiment and the asymmetric orthokeratology lens in the embodiment 1 in that: Outer edges of a base curve zone 1, a reverse curve zone 2, an adaptation curve zone 3, and a peripheral curve zone 4 are all circles whose center points are coincident with each other, to enable a first annular structure to form a circular ring. A curvature of an inner surface, located on a nasal side 6, of the circle is greater than a curvature of an inner surface, located on a bitemporal side 5, of the circle.

It may be understood that, because the first annular structure is a circle, widths of the first annular structure at all angles in the circumferential direction are the same. On the premise that the widths are equal, the curvature of the inner surface of the half-ring, located on the nasal side 6, of the circle may be increased, to enable the inner surface of the first annular structure on the nasal side 6 to be steeper compared to the inner surface of the first annular structure on the bitemporal side 5. Therefore, the space defined between the half-ring of the first annular structure located on the nasal side 6 and the cornea 7 is greater than the space defined between the half-ring of the first annular structure located on the bitemporal side 5 and the cornea 7. In the reverse curve zone 2, an amount of tears filled between the nasal side and the cornea 7 is not equal to an amount of tears filled between the bitemporal side and the cornea 7, and negative pressures on the nasal side and the bitemporal side are different. A defocusing ring may be formed at the cornea 7 on the nasal side 6 as far as possible. This effectively improves prevention and control effect of the asymmetric orthokeratology lens on myopia.

Specifically, as shown in FIG. 7, an inner surface of the base curve zone 1 is flat. The reverse curve zone 2 includes a first curve zone 21 and a second curve zone 22 that are continuously bent outward from a periphery of the base curve zone 1. A curvature of an inner surface, located on the nasal side 6, of the first curve zone 21 is equal to a curvature of an inner surface, located on the bitemporal side 5, of the first curve zone 21, or a curvature of an inner surface, located on the nasal side 6, of the second curve zone 22 is greater than a curvature of an inner surface, located on the bitemporal side 5, of the second curve zone 22.

It may be understood that, the curvature of the inner surface, located on the nasal side 6, of the first curve zone 21 is equal to the curvature of the inner surface, located on the bitemporal side 5, of the first curve zone 21. Therefore, the curvature of the first curve zone 21 is matched with the curvature of the base curve zone 1, and the first curve zone 21 may be relatively and stably fitted with the cornea 7, to provide necessary support, and ensure tears are distributed uniformly.

Due to the design that the curvature of the inner surface, located on the nasal side 6, of the second curve zone 22 is greater than the curvature of the inner surface, located on the bitemporal side 5, of the second curve zone 22, in the second curve zone 22, a force applied between the nasal side 6 and the cornea 7 and a force applied between the bitemporal side 5 and the cornea 7 are different. Therefore, distribution and circulation of the tears are affected. The curvature of the second curve zone 22 may be adjusted, so that filling of the tears and distribution of the forces can be further optimized, to improve prevention and control effect on myopia.

In this specification, the description of “one embodiment”, “some embodiments”, “an example”, “a specific example” and “some examples” means that a specific feature, structure, material or characteristic described in combination with the embodiment(s) or example(s) is included in at least one embodiment or example of the present disclosure. In this specification, the schematic representations of the above terms do not necessarily refer to the same embodiment or example. In addition, the specific features, structures, materials, or characteristics described may be combined in any suitable manner in any one or more embodiments or examples.

The above examples merely represent several implementations of the present disclosure, and the descriptions thereof are specific and detailed, but they should not be construed as limiting the patent scope of the present disclosure. It should be noted that those of ordinary skill in the art can further make several variations and improvements without departing from the concept of the present disclosure, and all of these fall within the protection scope of the present disclosure. Therefore, the protection scope of the patent of the present disclosure should be subject to the appended claims.

1. An asymmetric orthokeratology lens, comprising a base curve zone, and a reverse curve zone, an adaptation curve zone, and a peripheral curve zone that are successively formed outward from a periphery of the base curve zone, wherein an outer edge of the base curve zone is combined with an outer edge of the reverse curve zone, to form a first annular structure, and space defined between a half-ring of the first annular structure on a nasal side and a cornea is larger than space defined between a half-ring of the first annular structure on a bitemporal side and the cornea.

2. The asymmetric orthokeratology lens according to claim 1, wherein outer edges of the base curve zone, the adaptation curve zone, and the peripheral curve zone are all circles whose center points are coincident with each other, and a central point of the outer edge of the reverse curve zone is offset facing the nasal side, with a center point of the base curve zone as a reference point, and a width of the first annular structure located on the nasal side is larger than a width of the first annular structure located on the bitemporal side.

3. The asymmetric orthokeratology lens according to claim 2, wherein the outer edge of the reverse curve zone is a circle or an ellipse.

4. The asymmetric orthokeratology lens according to claim 1, wherein outer edges of the base curve zone, the adaptation curve zone, and the peripheral curve zone are all circles whose center points are coincident with each other, the outer edge of the reverse curve zone is surrounded by a semi-circular curve and a semi-elliptic curve, a center point of the semi-circular curve and a central point of the semi-elliptic curve coincide with a center point of the base curve zone, the semi-circular curve surrounds a side, facing the bitemporal side, of the base curve zone, the semi-elliptic curve surrounds a side, facing the nasal side, of the base curve zone, and a distance from a point on the semi-elliptic curve to the center point of the base curve zone is greater than or equal to a distance from a point on the semi-circular curve to the center point of the base curve zone, to enable a width of the first annular structure located on the nasal side to be greater than a width of the first annular structure located on the bitemporal side.

5. The asymmetric orthokeratology lens according to claim 1, outer edges of the reverse curve zone, the adaptation curve zone, and the peripheral curve zone are all circles whose center points are coincident with each other, an outer edge of the base curve zone is surrounded by a semi-circular curve and a semi-elliptic curve, a center point of the semi-circular curve and a central point of the semi-elliptic curve coincide with a center point of the reverse curve zone, the semi-circular curve is set facing the bitemporal side, the semi-elliptic curve is set facing the nasal side, and a distance from a point on the semi-elliptic curve to the center point of the reverse curve zone is less than or equal to a distance from a point on the semi-circular curve to the center point of the reverse curve zone, to enable a width of the first annular structure located on the nasal side to be greater than a width of the first annular structure located on the bitemporal side.

6. The asymmetric orthokeratology lens according to claim 1, wherein an inner surface of the base curve zone is flat, the reverse curve zone comprises a first curve zone and a second curve zone that are continuously bent outward from the periphery of the base curve zone, and a curvature of an inner surface of the first curve zone is less than or equal to a curvature of an inner surface of the second curve zone.

7. The asymmetric orthokeratology lens according to claim 6, wherein values of sagittal depths from points on an outer edge of the first curve zone to the base curve zone are the same.

8. The asymmetric orthokeratology lens according to claim 6, wherein a distance from an outer edge of the first curve zone in the bitemporal side to the base curve zone is equal to a distance from an outer edge of the first curve zone in the nasal side to the base curve zone;
a distance from an outer edge of the second curve zone in the bitemporal side to the first curve zone is less than a distance from the outer edge of the second curve zone in the nasal side to the first curve zone.

9. The asymmetric orthokeratology lens according to claim 8, wherein the distance from the outer edge of the second curve zone in the bitemporal side to the first curve zone is set to be X1, the distance from the outer edge of the second curve zone in the nasal side to the first curve zone is set to X2, and a difference between X2 and X1 is 0.1 mm to 0.4 mm.

10. The asymmetric orthokeratology lens according to claim 9, wherein the distance from the outer edge of the first curve zone in the bitemporal side to the base curve zone is set to X3, and a ratio of X3 to X1 is 1/3.

11. The asymmetric orthokeratology lens according to claim 1, wherein outer edges of the base curve zone, the reverse curve zone, the adaptation curve zone, and the peripheral curve zone are all circles whose center points are coincident with each other, to enable the first annular structure to form a circular ring, and a curvature of an inner surface, located on the nasal side, of the circle is greater than a curvature of an inner surface, located on the bitemporal side, of the circle.

12. The asymmetric orthokeratology lens according to claim 11, wherein an inner surface of the base curve zone is flat, the reverse curve zone comprises a first curve zone and a second curve zone that are continuously bent outward from the periphery of the base curve zone, a curvature of an inner surface, located on the nasal side, of the first curve zone is equal to a curvature of an inner surface, located on the bitemporal side, of the first curve zone, or a curvature of an inner surface, located on the nasal side, of the second curve zone is greater than a curvature of an inner surface, located on the bitemporal side, of the second curve zone.
